(19) United States
(12) Patent Application Publication
(10) Pub. No.: US 2026/0149528 A1
(43) Pub. Date: May 28, 2026

(54) METHODS AND PROCEDURES OF MAC LAYER SIGNALING FOR UNEQUAL MODULATION AND NEW MODULATION AND CODING SCHEMES IN WI-FI

(71) Applicant: InterDigital Patent Holdings, Inc., Wilmington, DE (US)

(72) Inventors: Ying WANG, Easton, PA (US); Hanqing LOU, Syosset, NY (US)

(73) Assignee: InterDigital Patent Holdings, Inc., Wilmington, DE (US)

(21) Appl. No.: 18/962,460

(22) Filed: Nov. 27, 2024

(51) Int. Cl. H04L 1/00; H04L 5/00

(52) U.S. Cl. CPC H04L 1/0003; H04L 5/0053

(57) ABSTRACT

Procedures for link adaptation and signaling are disclosed herein to support multiple modulation and coding schemes (MCSs) and equal modulation (EQM) and unequal modulation (UEQM). A first station (STA) may transmit, to a second STA, a first physical protocol data unit (PPDU) that can be used to estimate channel conditions between the first and second STA. The First STA may receive, from the second STA, a second PPDU including a medium access control (MAC) frame including a MAC header and a MAC frame body, wherein the MAC header comprises a control subfield further comprising a control subfield variant, wherein the control subfield variant comprises modulation and coding scheme (MCS) feedback (MFB) information, wherein the MFB information includes an indication of unequal modulation (UEQM) and UEQM information. The first STA may transmit, to the second STA, a third PPDU using at least one modulation scheme based on the received MFB information.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is peer-to-peer traffic, which may also be sent directly between the source and destination STAs with a direct link setup (DLS) using an 802.11e DLS or an 802.11z tunneled DLS (TDLS). A WLAN using Independent BSS (IBSS) mode has no AP, and the STAs using such an IBSS may communicate directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the occupancy or vacancy of the primary channel. If the channel is detected to be busy, the STA backs off. Hence only one STA may transmit at any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHZ, 80 MHZ, and 160 MHz wide channels. The 40 MHz and 80 MHz channels are formed by combining contiguous 20 MHz channels as described above for 802.11n. A 160 MHz channel may be formed either by combining 8 contiguous 20 MHz channels, or by combining two non-contiguous 80 MHz channels, which may be referred to as an 80+80 configuration. For the 80+80 configuration, at the transmitter, the data, after channel encoding, may be passed through a segment parser that divides the data into two streams. Inverse fast Fourier transform (IFFT) and time domain processing are done on each stream separately. The two streams are then mapped onto the two 80 MHz channels for transmission. At the receiver, this mechanism is reversed, and the combined data from the two 80 MHz channels is sent to the medium access control (MAC) layer.

In 802.11ax, High Efficiency (HE) Wireless STAs may support 20 MHZ, 40 MHz, 80 MHZ, and/or 160 MHz wide channels capable of transmission over 2.4 GHZ, 5 GHZ, and 6 GHz frequency bands using both orthogonal frequency-division multiple access (OFDMA) and multi-user multiple-input multiple-output (MU-MIMO) capabilities. OFDMA subcarrier modulation in HE STAs includes formats such as BPSK, QPSK, 16-QAM, 64-QAM, 256-QAM, and 1024-QAM. The evolution of 802.11 to Extremely High Throughput (EHT, or 802.11be) STAs extends to having 320 MHz wide channels.

Sub 1 GHz modes of operation are supported by 802.11af and 802.11ah. For these specifications the channel operating bandwidths, and the number of Orthogonal frequency-division multiplexing (OFDM) subcarriers, are reduced relative to those used in 802.11n and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel is therefore limited by the STA that supports the smallest bandwidth operating mode in the BSS. In the example of 802.11ah, the primary channel may be 1 MHz wide if there are STAs (e.g. MTC type devices) that only support a 1 MHz mode even if the AP, and other STAs in the BSS, may support 2 MHZ, 4 MHZ, 8 MHZ, 16 MHZ, or other channel bandwidth operating modes. All carrier sensing and NAV settings depend on the status of the primary channel, i.e., if the primary channel is busy, for example, due to a STA supporting only a 1 MHz operating mode is transmitting to the AP, then the entire available frequency bands are considered busy even though majority of it stays idle and available.

To improve spectral efficiency, 802.11n started to introduce the multiple-input multiple-output (MIMO) technology, which multiplies capacity by transmitting up to 4 spatial streams (or data streams) over different antennas. 802.11ac further introduced downlink multi-user MIMO (MU-MIMO) transmission, where multiple users may send their spatial streams (max 4 per user, total up to 8) over different antennas simultaneously on the same frequency, i.e., on the same OFDM subcarrier and in the same OFDM symbol. 802.11ax and 802.11be use both orthogonal frequency-division multiple access (OFDMA), which is multiplexing users in the frequency domain, and UL/DL MU-MIMO, which is multiplexing users in the spatial domain.

The IEEE 802.11 Ultra High Reliability (UHR), or 802.11bn, Study Group was formed in September 2022. UHR is considered as the next major revision to IEEE 802.11 standards following 802.11be (or EHT), which is currently in the Working Group Letter Ballot Stage. UHR explores the possibility to improve reliability, support further reduced low latency traffic, further increase peak throughput, improve power saving capabilities, and improve efficiency of the IEEE 802.11 network over EHT.

### SUMMARY

Procedures for link adaptation and signaling, including medium access control (MAC) signaling, are disclosed herein to support multiple modulation and coding schemes (MCSs) and equal modulation (EQM) and unequal modulation (UEQM). A first station (STA) may transmit, to a second STA, a first physical protocol data unit (PPDU) that can be used to estimate channel conditions between the first STA and the second STA. The First STA may receive, from the second STA in response to the first PPDU, a second PPDU including a medium access control (MAC) frame including a MAC header and a MAC frame body, wherein the MAC header comprises a control subfield further comprising a control subfield variant, wherein the control subfield variant comprises modulation and coding scheme (MCS) feedback (MFB) information, wherein the MFB information includes an indication of unequal modulation (UEQM) and UEQM information. The first STA may transmit, to the second STA, a third PPDU using at least one modulation scheme based on the received MFB information.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a frame format diagram illustrating an example 802.11 medium access control (MAC) frame format;

FIG. 2B is a frame format diagram illustrating an example High Throughput (HT) Control field format;

FIG. 3 is a frame format diagram illustrating an example Control Information subfield format in an Extremely High Throughput (EHT) link adaptation (ELA) Control subfield;

FIG. 4 is a frame format diagram illustrating an example Element format;

FIG. 5 is a frame format diagram illustrating an example EHT Capabilities element format;

FIG. 6 is a frame format diagram illustrating an example Ultra High Reliability (UHR) Capabilities element format;

FIG. 7 is a frame format diagram illustrating an example EHT physical layer (PHY) Capabilities Information field format;

FIG. 8 is a frame format diagram illustrating an example ULA Control subfield (Variant 1) format;

FIG. 9 is a frame format diagram illustrating another example ULA Control subfield (Variant 1) format;

FIG. 10 is a signaling diagram illustrating an example link adaptation procedure using a request and response approach;

FIG. 11 is a signaling diagram illustrating an example link adaptation procedure using unsolicited modulation and coding scheme (MCS) feedback (MFB) response for transmitting UHR multi-user (MU) physical protocol data units (PPDUs) or non-trigger-based (non-TB) PPDUs;

FIG. 12 is a signaling diagram illustrating an example link adaptation procedure using unsolicited response for UHR TB PPDUs; and

FIG. 13 is a flow diagram illustrating an example procedure for medium access control (MAC) layer signaling to enable equal and unequal modulation across spatial streams and accommodate new modulation and coding schemes for transmission.

### DETAILED DESCRIPTION

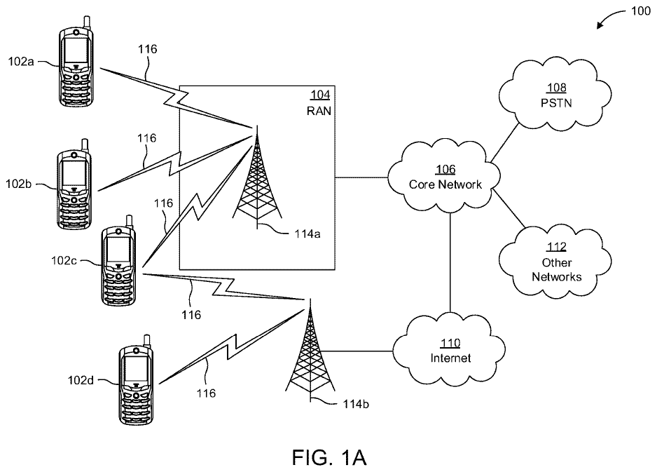

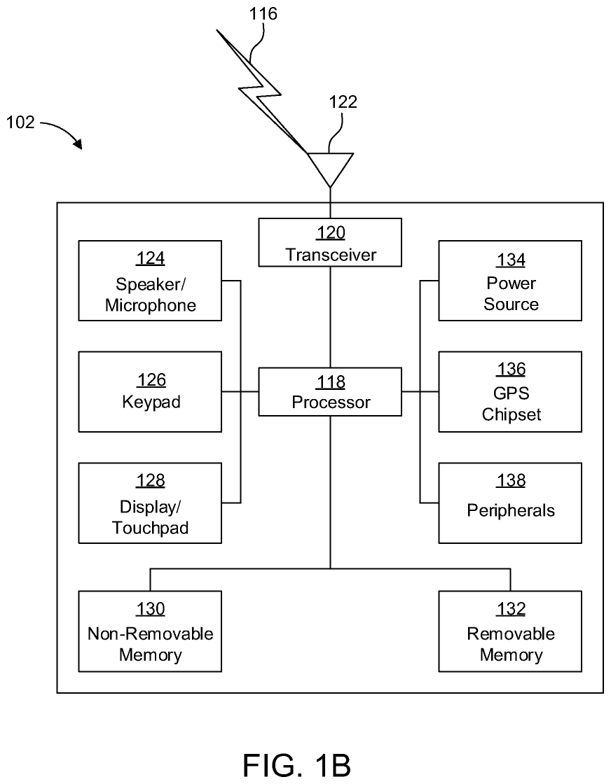

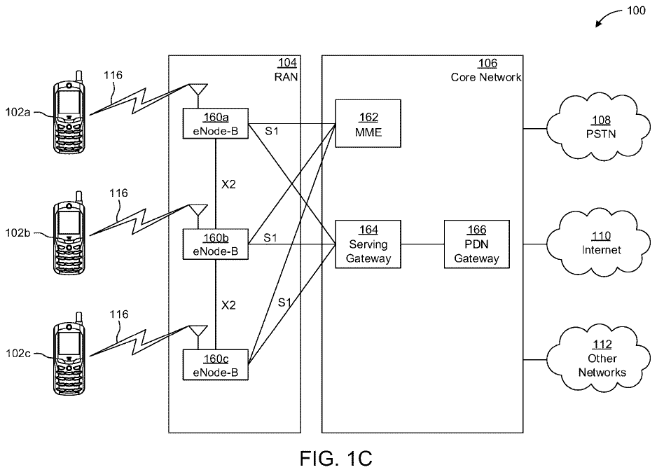

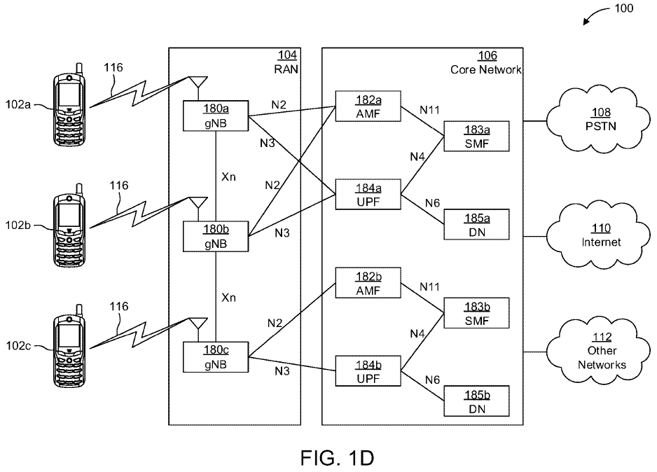

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHZ, 80 MHZ, and/or 160 MHz wide channels transmitted over a 5 GHz frequency band using OFDMA. The 40 MHZ, and/or 80 MHZ, channels may be formed by combining contiguous 20 MHz channels. A 160 MHz channel may be formed by combining 8 contiguous 20 MHZ channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHZ, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability (UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

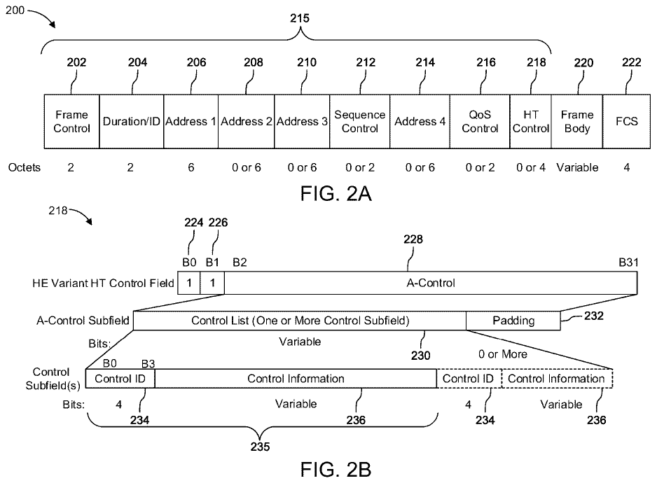

FIG. 2A is a frame format diagram illustrating an example 802.11 medium access control (MAC) frame 200 format. MAC frame 200 may include various fields grouped in a MAC header 215, a Frame Body 220, and Frame Check Sequence (FCS) field 222. The MAC Header 215 may include, but is not limited to include, any of the following fields: frame control field 202; duration/identity (ID) field 204; address fields 206, 208, 210; sequence control field 212; address field 214; Quality of Service (QOS) control field 216; and/or High Throughput (HT) control field 218. Example numbers of octets for each field are shown in FIG. 2A (“v” or variable refers to a variable size).

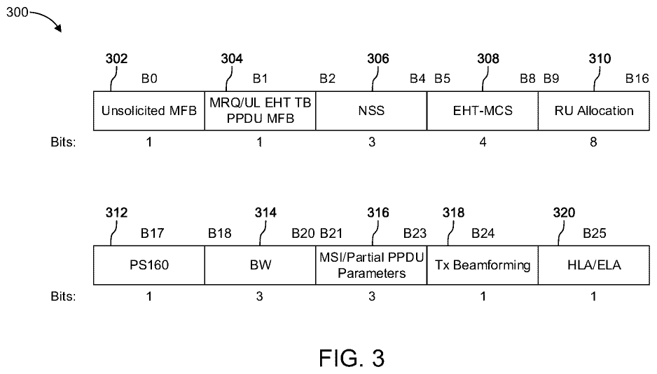

As shown in FIG. 2A, the HT Control field 218 may be present in the MAC header 215 of a MAC frame 200. FIG. 2B is a frame format diagram illustrating an example HT Control field 218 format. In an example, if the HT Control field 218 has a value ‘1’ in both first two bits 224 and 226 (e.g., bits B0 and B1 of bits B0-B31), then the HT Control field 218 is an HE variant and bits B2-B31 may be referred to as an A-Control subfield 228, which may be further formatted as a Control List subfield 230 with (or without) padding bits 232. The Control List subfield 230 may contain one or more Control subfields 235 made up of a Control ID subfield 234 (e.g., the first 4 bits) and the Control Information field 236 (e.g., a variable number of bits). The Control ID field 234 may indicate the type of information carried in the Control Information subfield 236. In an example of HE, the Control ID field 234 with a value of ‘2’ may be assigned to HE link adaptation (HLA) and the Control Information subfield 236 may use 26 bits to carry information related to the HLA procedure. In an example of Extremely High Throughput (EHT), the Control ID 234 with a value of ‘2’ may be used for EHT link adaptation (ELA) and the last bit (e.g., bit B25) of the 26-bit Control Information subfield 236 may be used to indicate whether the Control subfield 235 is defined as an HLA Control subfield 235 (if bit B25=‘0’) or an ELA Control subfield 235 (if bit B25=′1′). An example of the Control Information subfield 236 format in an ELA Control subfield 235 is shown in FIG. 3.

FIG. 3 is a frame format diagram illustrating an example Control Information subfield 300 format in an ELA Control subfield. In the ELA Control subfield 300, bits may be allocated to subfields including, but not limited to, any of the following example subfields: Unsolicited MCS feedback (MFB) subfield 302, modulation and coding scheme (MCS) request (MRQ) subfield 304/uplink (UL) EHT trigger-based (TB) physical layer (PHY) protocol data unit (PPDU) MFB subfield 304, number of spatial streams (NSS) subfield 306, (EHT) Modulation and Coding Scheme (MCS) subfield 308, resource unit (RU) Allocation subfield 310, PS160 subfield 312, Bandwidth (BW) subfield 314, MRQ Sequence Identifier (MSI) subfield 316/partial PPDU Parameters subfield 316, transmit (Tx) Beamforming subfield 318, and/or HLA/ELA indication(s) 320. Example numbers of bits for each of the subfields are shown.

In an example of current EHT systems, there are 14 management frame subtypes defined for EHT, including Beacon, Association Request/Response, Reassociation Request/Response, Probe Request/Response, Timing Advertisement, Announcement Traffic Indication Message (ATIM), Disassociation, Authentication/Deauthentication, Action, and Action No Acknowledgment (Ack) frames. Management frame subtypes may be used to manage the BSS, and may be used to help STAs find, authenticate, and/or associated with an AP. The Management frame body consists of fields and elements that are specifically defined for the management frame subtypes.

Some agreed PHY features for 802.11bn include defining unequal modulation (UEQM) over different spatial streams for LDPC codes and adding new Modulation and Coding Schemes (MCSs). Example modulation and code rate combinations that may be added as new MCSs in 802.11bn include: Modulations of {QPSK, 16QAM, 256QAM} with code rate R=2/3; and Modulation of 16QAM with code rate R=5/6. In the case that these four modulation and code rate combinations are added to the 16 EHT-MCSs, the total number of MCSs in an example future system, such as UHR, is 20. In this case, 5 bits instead of 4 bits are needed to signal 20 MCSs.

In terms of the UEQM support, Table 1, Table 2, and Table 3 give examples of the possible UEQM patterns that may be used in 802.11bn. The constellation index M for the first spatial stream in each table is called the base modulation order. The base modulation order together with a code rate R is mapped to an MCS index, which is called a base MCS. Therefore, the base MCS, the number of spatial streams NSS, and a UEQM pattern would completely specify the coding and modulation scheme for UEQM.

TABLE 1
UEQM patterns for 4 spatial streams, where M is a constellation index,
M-1 refers to the constellation that is one order lower than M, and
M-2 refers to the constellation that is two orders lower than M

| Pattern Index | 1^{st} ss | 2^{nd} SS | 3^{rd} SS | 4^{th} SS |
|---|---|---|---|---|
| 0 | M | M | M | M-1 |
| 1 | M | M | M | M-2 |
| 2 | M | M | M-1 | M-2 |
| 3 | M | M-1 | M-1 | M-2 |

TABLE 2
UEQM patterns for 3 spatial streams

| Pattern Index | 1^{st} ss | 2^{nd} SS | 3^{rd} SS |
|---|---|---|---|
| 0 | M | M | M-1 |
| 1 | M | M | M-2 |
| 2 | M | M-1 | M-2 |

TABLE 3
UEQM patterns for 2 spatial streams

| Pattern Index | 1^{st} ss | 2^{nd} SS |
|---|---|---|
| 0 | M | M-1 |
| 1 | M | M-2 |

To support UEQM over spatial streams and/or even frequency segments, some MAC layer signaling is needed to indicate whether the AP or non-AP STA has the capability to support UEQM over spatial streams and/or even frequency segments, and, when supported, to indicate the limits of the support. Moreover, the introduction in 802.11bn of more MCSs and EQM/UEQM support requires updates to the link adaptation process and signaling. Thus, procedures are described herein for indicating, as part of MAC layer signaling, support for UEQM and for link adaptation and signaling to handle more MCSs and EQM/UEQM support.

It may be appreciated that one or more fields of a frame described and illustrated in the context for a particular 802.11 amendment, may also apply to different and/or future 802.11 amendments based on having the same functionality. For example, the present disclosure refers to an HT Control field having different fields such as a ULA Control subfield. It is therefore contemplated that the same ULA Control subfield or another field having the same functionality as the ULA Control subfield may be present in a field/frame of a future 802.11 amendment. A ULA Control subfield or a functional equivalent of the ULA Control subfield in the current HT Control field, may be found in, for example, future HT Control field(s).

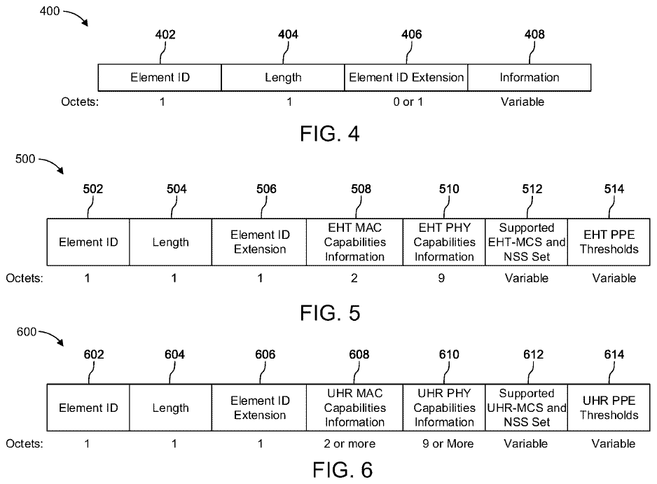

According to an example embodiment, related elements may be included in a Management Frame Body. For example, UHR Capabilities Element may be included in a Management Frame Body. If a STA (AP or non-AP) is capable of acting as a UHR STA and intends to declare itself as a UHR STA, a UHR Capabilities element may be included in management frames such as Beacon, Probe Request/Response, Association Request/Response, Reassociation Request/Response, Operating Mode Notification, TDLS Discovery Request/Response, Channel Usage Request, and/or Mesh Peering Open frame. FIG. 4 is a frame format diagram illustrating an example Element 400 format. Element 400 may include Element ID field 402, length field 406, Element ID Extension field 408 and information field 410. When Element ID field 402 has a value of 255 and Element ID Extension field 408 has a value picked from 117 to 132, 138 to 140, or 144-255, Element 400 is defined as a new element, UHR Capabilities Element, and the following Information field 410 contains UHR capabilities information.

FIG. 5 is a frame format diagram illustrating an example EHT Capabilities element 500 format (further detailing the content of the Information field 410 in FIG. 4). EHT Capabilities element 500 may include Element ID field 502, length field 506, Element ID Extension field 508, and the following fields that may be included in an Information field (e.g., Information field 410 in FIG. 4): EHT MAC Capabilities Information field 510, EHT PHY Capabilities Information field 512, Supported EHT-MCS and NSS Set field 514, and EHT Physical-layer Packet Extension (PPE) Thresholds field 516.

FIG. 6 is a frame format diagram illustrating an example UHR Capabilities element 600 format. The Information field of the UHR capabilities element 600 may include several fields that are used to advertise the UHR capabilities of a UHR STA. For example, UHR Capabilities element 600 may include Element ID field 602, length field 606, Element ID Extension field 608, and the following fields that may be included in an Information field (e.g., Information field 410 in FIG. 4): UHR MAC Capabilities Information field 610, UHR PHY Capabilities Information field 612, Supported UHR-MCS and NSS Set field 614, and UHR PPE Thresholds field 616.

In an example, a UHR MAC Capabilities Information field may be used. In an example UHR MAC Capabilities Information field, there may be two bits for UHR Link Adaptation Support that indicate whether or not the STA can provide MCS feedback (MFB), and if the STA can provide MFB, whether the STA can receive and provide solicited or unsolicited MFB. With the introduction of UEQM in UHR, an additional bit may be used in the UHR Link Adaptation Support subfield to indicate whether UEQM is supported in the STA's capabilities of providing MFB and the STA's support of solicited or unsolicited MFB.

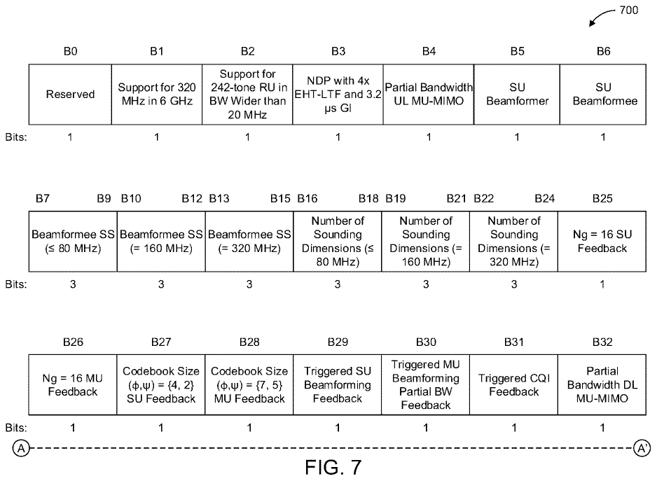

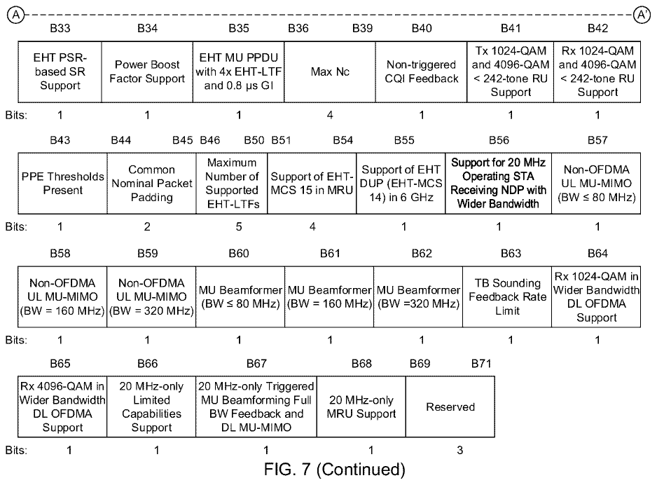

In an example, a UHR PHY Capabilities Information field may be used. FIG. 7 is a frame format diagram illustrating an example EHT PHY Capabilities Information field 700 format. An EHT PHY Capabilities Information field 700 has many subfields to indicate various PHY capabilities of an EHT STA. In an example embodiment, a UHR PHY Capabilities Information field format may use any of the subfields in the EHT PHY Capabilities Information field format as shown in FIG. 7, and may further add new subfields. For example, a UEQM And New MCSs subfield may be added to a UHR PHY Capabilities Information field to indicate any of the following information: if UEQM is supported, if new MCSs are supported, the maximum number of supported spatial streams with UEQM, the supported maximum base modulation order or base MCS, and/or the supported minimum base modulation order or base MCS. In an example, new subfields may be allocated in the UHR PHY Capabilities Information field to indicate any of the following information: support of enhanced long range (ELR), support of distributed resource unit (DRU), support of enhanced LDPC (2xLDPC), and/or support of additional pilots for interference mitigation.

Similar to the Supported EHT-MCS And NSS Set field for EHT, a Supported UHR-MCS and NSS Set field may be combined with the aforementioned new UEQM and New MCSs subfield in the UHR MAC/PHY Capabilities Information field to indicate the combinations of UHR-MCSs and number of spatial streams NSS that a STA supports for reception and the combinations that it supports for transmission, both when UEQM transmission is used and when EQM transmission is used. Such information is referred to as UHR-MCS Maps. In an example, the subfields of the Supported UHR-MCS and NSS Set field may include UHR-MCS Maps for STAs with different operating bandwidths (e.g., 20 MHz only, <=80 MHZ, 160 MHz, 320 MHz) to indicate the following: when only EQM transmission is used, for each MCS value and different PPDU bandwidths, the maximum number of spatial streams that a STA can support for reception and the maximum number of spatial streams that the STA can support for transmit; and/or if UEQM transmission is supported, and when UEQM transmission is used, the supported number of spatial streams, their associated UEQM patterns, and the associated maximum/minimum supported base modulation or base MCS for reception and transmission of a PPDU of different bandwidths.

Another new element that may be added for UHR is a UHR Operation element, providing additional information for operating the UHR BSS. For example, UHR Operation element may be present in management frames (e.g., Beacon, Association Response, Reassociation Response, Probe Response, and/or TDLS Setup Response). The UHR Operation element may also have the same element format as shown in FIG. 4, for example with an Element ID value of 255 and an Element ID Extension having a value picked from 117 to 132, 138 to 140, or 144-255. The UHR Operation element may have a similar format as the EHT Operation element to include fields such as UHR Operation Parameters, Basic UHR-MCS and NSS Set, and UHR Operation Information. The Basic UHR-MCS and NSS Set subfield in the UHR Operation element, which indicates the basic modulation and coding capabilities that are supported by all UHR STAs in the BSS for transmission and reception, may have the same format as the UHR-MCS Map subfield for 20 MHz only non-AP STAs in the Supported EHT-MCS And NSS Set field of the UHR Capabilities element. Similarly, this Basic UHR-MCS and NSS Set subfield may be interpreted differently depending on whether an UEQM/EQM indicator is signaled in other fields of a UHR Operation element (e.g., UHR Operation Parameters).

In an example, UHR Capabilities Subelement and/or UHR Operation Subelement may be in a Neighbor Report Element. In an example, upon receiving a neighbor report request from a STA, an AP may return a neighbor report containing information about known neighbor APs that are candidates for a service set transition. This enables a STA to gain information about the neighbors of the associated AP to be used as potential BSS transition candidates. A Neighbor Report element may add new UHR Capabilities and/or UHR Operation subelements to report on a UHR neighbor's capabilities and operation parameters. In an example, the subelement IDs of the UHR Capabilities and/or UHR Operation subelements may use current reserved values such as 7-38, 40-44, 46-60, 63-65, 67-69, 72-190, 199-220, or 222-255. In an example, the Data field of the UHR Capabilities subelement, and similarly the Data field of the UHR Operation subelement, may have the same format as the Information field of the UHR Capabilities element and hence all the UEQM/EQM and new MCSs related modifications may apply.

In an example, UHR Link Adaptation may use an A-Control Subfield of an HE Variant HT Control Field in the MAC Header. In an example, the UHR Link Adaptation may be a UHR Link Adaptation (ULA) Control Subfield (Variant 1). Similar to the HLA/ELA Control subfields in HE and EHT, ULA Control subfield in the A-Control subfield of the HE variant HT Control field in MAC headers may be used for UHR. However, given the full bit allocation in the HLA/ELA Control subfield, the same Control ID value of 2 may no longer be reusable for ULA and still be able to specify if the Control subfield is HLA, ELA, or ULA. In an example, a new Control ID may be assigned to ULA Control, and may be selected from available Control ID values (e.g., 10 to 14). In addition to the 4 bits for Control ID, the ULA Control subfield may have 26 bits to carry control information, for example using fields: Unsolicited MFB, MRQ, UL UHR TB PPDU MFB, NSS, UHR-MCS, RU Allocation, BW, PS160, BW, and/or MSI. In an example, the ULA Control subfield may have the same Control Information subfield format in an ELA Control subfield with some modifications.

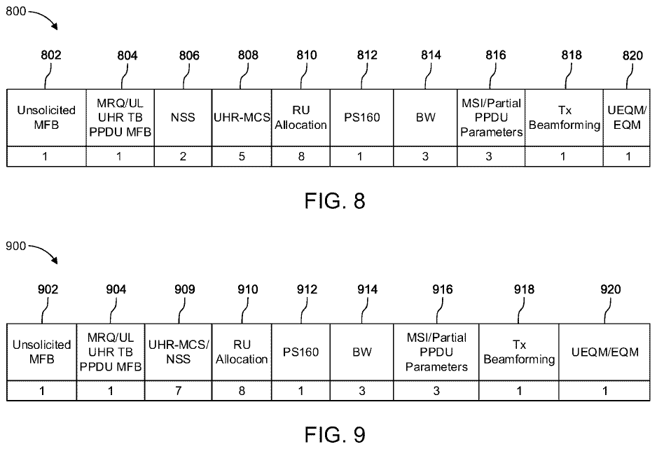

To accommodate UEQM versus EQM selection, a bit may be used as a UEQM/EQM indicator. To further accommodate the greater number of UHR-MCSs (e.g., 20), the UHR-MCS subfield may use more bits, for example 5 bits instead of 4 bits. FIG. 8 is a frame format diagram illustrating an example ULA Control subfield (Variant 1) 800 format. ULA Control subfield (Variant 1) 800 may include any of the following subfields: Unsolicited MFB subfield 802, MRQ/UL UHR TB PPDU MFB subfield 804, NSS subfield 806, UHR MCS subfield 808, RU Allocation subfield 810, PS160 subfield 812, BW subfield 814, MSI/partial PPDU Parameters subfield 816, Tx Beamforming subfield 818, and/or UEQM/EQM indication field 820. Example numbers of bits for each of the subfields are shown. As shown in FIG. 8, bit B25 of the ULA Control subfield 800 (i.e., the location which carried HLA/ELA bit in the ELA subfield) may be used as the UEQM/EQM indicator 820. If EQM is indicated, 2 bits may be allocated to the NSS subfield 806 (instead of 3 bits in EHT hence limiting the maximum NSS per user to 4), and 5 bits may be allocated to the UHR-MCS subfield 808 (instead of 4 bits in EHT). If UEQM is indicated, 7 bits may be allocated to the NSS subfield 806 and the UHR-MCS subfield 808 combined to signal 128 selected UEQM combinations of (base UHR-MCS, UEQM pattern) that may be pre-defined in a table.

FIG. 9 is a frame format diagram illustrating another example ULA Control subfield (Variant 1) 900 format. ULA Control subfield (Variant 1) 900 may include any of the following subfields: Unsolicited MFB subfield 902, MRQ/UL UHR TB PPDU MFB subfield 904, NSS and UHR MCS combined subfield 909, RU Allocation subfield 910, PS160 subfield 912, BW subfield 914, MSI/partial PPDU Parameters subfield 916, Tx Beamforming subfield 918, and/or UEQM/EQM indication field 920. As shown in FIG. 9, the HLA/ELA bit in EHT may be allocated as the UEQM/EQM indicator 920 and the 3-bit NSS subfield and 4-bit MCS subfield in EHT may be combined into one 7-bit NSS/UHR-MCS subfield 909 in the ULA Control subfield 900. When the UEQM/EQM indicator 920 is ‘0’ for EQM, the 7-bit value in the NSS/UHR-MCS subfield 909 may be mapped to 128 EQM combinations of (NSS, UHR-MCS) that may be pre-defined in a table. By doing this, the maximum NSS value is not limited to 4 bits. When the UEQM/EQM indicator 920 is ‘1’ for UEQM, the 7-bit value in the NSS/UHR-MCS subfield 909 may be mapped to 128 selected UEQM combinations of (base UHR-MCS, UEQM pattern) in another pre-defined table.

In another example, 8 bits may be allocated to a combined Modulation subfield; the 8 bits may be located apart within the ULA Control subfield as shown in FIG. 9 or they could be consecutive bits by modifying the bit assignment to other subfields. The 8-bit value in the Modulation subfield may be mapped to 256 combinations of (EQM, NSS plus UHR-MCS) or (UEQM, base UHR-MCS plus UEQM pattern) in corresponding pre-defined table. The meaning of other subfields defined in the ULA subfield may remain the same as that defined in HLA subfield in 802.11ax, for example. The MRQ/UL UHR TB PPDU MFB subfield may follow the definition of MRQ/UL EHT TB PPDU MFB subfield in ELA subfield defined in 802.11be. In an example, the UEQM/EQM subfield may also be used to indicate the preference of UEQM or EQM for the upcoming PPDU(s). For example, the UEQM/EQM subfield being set to ‘1’ may indicate that UEQM is recommended. Consequently, the other subfields carried in the ULA Control subfield may indicate the recommended parameters for UEQM. Similarly, the UEQM/EQM subfield being set to ‘0’ may indicate that EQM is recommended and the other subfields carried in the ULA Control subfield may then indicate the recommended parameters for EQM. Example meanings for values of combinations of the UEQM/EQM subfield, Unsolicited MFB subfield, and MRQ/UL UHR TB PPDU MFB subfield are given in Table 4.

TABLE 4
Example combination of values of UEQM/EQM subfield, Unsolicited MFB subfield,
and MRQ/UL UHR TB PPDU MFB subfield for ULA Control subfield (Variant 1)

| | Unsolicited | MRQ/UL UHR | |
|---|---|---|---|
| UEQM/EQM | MFB | TB PPDU MFB | Meaning |
| 1 | 0 | 1 | Request for a ULA feedback for UEQM |
| 1 | 0 | 0 | Response for a ULA UEQM request |
| 1 | 1 | 1 | Unsolicited MFB, UEQM is recommended. The |
| | | | parameters included in the Control subfield are |
| | | | recommended UEQM MFB for subsequent UHR |
| | | | TB PPDU |
| 1 | 1 | 0 | Unsolicited MFB, UEQM is recommended. The |
| | | | parameters included in the Control subfield are |
| | | | recommended UEQM MFB for subsequent UHR |
| | | | MU PPDU or UHR non-TB PPDU |
| 0 | 0 | 1 | Request for a ULA feedback for EQM |
| 0 | 0 | 0 | Response to a ULA EQM request |
| 0 | 1 | 1 | Unsolicited MFB, EQM is recommended. The |
| | | | parameters included in the Control subfield are |
| | | | recommended EQM MFB for subsequent UHR |
| | | | TB PPDU |
| 0 | 1 | 0 | Unsolicited MFB, EQM is recommended. The |
| | | | parameters included in the Control subfield are |
| | | | recommended EQM MFB for subsequent UHR |
| | | | MU PPDU or UHR non-TB PPDU |

In another example, the UHR Link Adaptation may be a ULA Control Subfield (Variant 2). In an example, because the ULA Control subfield (Variant 1) defined above may not have enough bits to signal 3-bit NSS and 5-bit UHR-MCS (8 bits total), a ULA Control subfield (Variant 2) may be defined with Control ID value selected from 10 to 14, in parallel to the HLA/ELA Control subfield. In this new ULA Control subfield, 5 bits may be allocated to UHR-MCS to indicate the MCS used for all spatial streams and 3 bits may be allocated for NSS to indicate the number of spatial streams. An example of the bit allocation for ULA Control subfield (Variant 2) is shown in Table 5. Other subfields such as Unsolicited MFB, MRQ/UL UHR TB PPDU MFB, RU Allocation, PS160, BW, MSI/Partial PPDU Parameters, and TX Beamforming may have the same definition as in HLA/ELA Control subfield, or as described earlier for ULA Control subfield (Variant 1). In an example, in contrast to ULA Control subfield (Variant 1), the EQM/UEQM bit may be removed for ULA Control Subfield (Variant 2) to allow an additional bit for UHR-MCS field. In this case, if Unsolicited MFB is ‘0’ and MRQ/UL UHR TB PPDU MFB is ‘1’, the ULA Control subfield (Variant 2) is a solicitation/request for MFB, and the solicited MFB may be based on either EQM or UEQM (i.e., not limited to EQM). If Unsolicited MFB is ‘0’ and MRQ/UL UHR TB PPDU MFB is ‘0’, the ULA Control subfield (Variant 2) is an EQM MFB to a previous MRQ. If a STA wants to send a UEQM MFB, the STA could use the UEQM Feedback Control subfield or the UEQM/DRU Feedback Control subfield described below. If Unsolicited MFB is ‘1’ and MRQ/UL UHR TB PPDU MFB is ‘1’, the ULA Control subfield (Variant 2) is a unsolicited EQM MFB recommended for subsequent UHR TB PPDUs. If Unsolicited MFB is ‘1’ and MRQ/UL UHR TB PPDU MFB is ‘0’, the ULA Control subfield (Variant 2) is a unsolicited EQM MFB recommended for subsequent UHR MU or non-TB PPDUs. Table 6 shows the meanings and actions defined by the Unsolicited MFB subfield and the MRQ/UL UHR TB PPDU MFB subfield in the ULA Control subfield (Variant 2).

TABLE 5
Exemplary design for Link Adaptation Control subfield (Variant 2)

| | MRQ/UL | | | | | | | |
|---|---|---|---|---|---|---|---|---|
| | UHR TB | | | | | | MSI/Partial | |
| Unsolicited | PPDU | | UHR- | RU | | | PPDU | TX |
| MFB | MFB | NSS | MCS | Allocation | PS160 | BW | Parameters | beamforming |
| 1 bit | 1 bit | 3 bits | 5 bits | 8 bits | 1 bit | 3 bits | 3 bits | 1 bit |

TABLE 6
Example of combination settings of Unsolicited MFB subfield and MRQ/UL
UHR TB PPDU MFB subfield for ULA Control subfield (Variant 2)

| Unsolicited | MRQ/UL UHR | |
|---|---|---|
| MFB | TB PPDU MFB | Meaning |
| 0 | 1 | Request for a ULA feedback; the feedback could |
| | | be for UEQM or EQM |
| 0 | 0 | Response for a ULA request with EQM |
| | | suggestions |
| 1 | 1 | Unsolicited MFB, EQM is recommended. The |
| | | parameters included in the Control subfield are |
| | | recommended EQM MFB for subsequent UHR |
| | | TB PPDU. IF UEQM is recommended, use the |
| | | UEQM Feedback Control subfield or the |
| | | UEQM/DRU Feedback Control subfield |
| | | (described below) |
| 1 | 0 | Unsolicited MFB, EQM is recommended. The |
| | | parameters included in the Control subfield are |
| | | recommended EQM MFB for subsequent UHR |
| | | MU PPDU or UHR non-TB PPDU. IF UEQM is |
| | | recommended, use the UEQM Feedback Control |
| | | subfield or the UEQM/DRU Feedback Control |
| | | subfield (described below) |

In another example embodiment, a UEQM Feedback Control Subfield may be used. In an example, parallel to the HLA/ELA Control subfield definition, a UEQM Feedback Control subfield may be defined and a Control ID value of 10 to 14 may be used to indicate the UEQM Feedback Control subfield. The UEQM Feedback Control subfield may include recommended parameters for UEQM transmissions in the following/upcoming PPDUs. The UEQM Feedback Control subfield may be used together with either of the ULA Control subfield variants defined previously. The UEQM Feedback Control subfield may include any one or more of the following subfields (e.g., using 26 bits). The Base MCS (5 bits) subfield may indicate the base MCS recommended for the following/upcoming PPDU. The base MCS may be recommended for the first spatial stream of the following/upcoming PPDU. The UEQM Pattern Index (2 bits) subfield may be interpreted with the NSS subfield to indicate the UEQM pattern recommended for the following/upcoming PPDU. For example, if NSS=4, the UEQM Pattern Index may be interpreted according to Table 1; if NSS=3, UEQM Pattern Index may be interpreted according to Table 2; and if NSS=2, UEQM Pattern Index may be interpreted according to Table 3.

The NSS (3 bits) subfield may indicate the number of spatial streams recommended for the following/upcoming PPDU. In an example, the NSS subfield and UEQM Pattern Index subfield may be merged into one subfield. For example, one value of the subfield may indicate the number of spatial streams and the UEQM pattern index. The BF (1 bit) subfield may indicate whether beamforming may be used in the upcoming PPDU with the recommended parameters. The UEQM Preference (1 bit) subfield may indicate whether UEQM is preferred or recommended for the following/upcoming PPDU. The PS160 (1 bit) subfield may indicate the primary 160 MHz channel or second 160 MHz channel for the RU or MRU allocation if the size of RU or MRU is smaller than or equal to 2×996 tones. Otherwise, the PS160 subfield may indicate the RU or MRU index along with the RU Allocation subfield. The RU Allocation (8 bits) subfield may indicate the RU or MRU for which the UEQM Feedback Control is recommended. The RU Allocation subfield may be interpreted with the BW subfield to specify the RU. The BW (3 bits) subfield may indicate the bandwidth for which the UEQM Feedback Control is recommended. The BW subfield may be interpreted with the RU Allocation subfield to specify the RU. The Target PPDU Type (2 bits) subfield may indicate the PPDU type (i.e., MU/SU PPDU or TB PPDU) for which all the above parameters carried in the UEQM Feedback Control subfield are recommended.

In another example embodiment, a UEQM/DRU Feedback Control Subfield may be used. In an example, in addition to the HLA/ELA Control subfield, a UEQM/DRU Feedback Control subfield may be defined and a Control ID value of 10 to 14 may be used to indicate the UEQM Feedback Control subfield. The UEQM/DRU Feedback Control subfield may carry recommended parameters for UEQM and/or distributed RU transmissions in the following/upcoming PPDUs. The UEQM/DRU Feedback Control subfield may be used together with either of the ULA Control subfield variants defined previously. The UEQM/DRU Feedback Control subfield any one or more of the following subfields. The UEQM/DRU Indication (1 bit) subfield may indicate whether UEQM or DRU is recommended. The Base MCS (5 bits) subfield may indicate the base MCS recommended for the following/upcoming PPDU. In the case the UEQM/DRU Indication subfield indicates UEQM, the base MCS may be recommended for the first spatial stream of the following/upcoming PPDU. In the case the UEQM/DRU Indication subfield indicates DRU, the base MCS may be recommended for the DRU transmission in the following/upcoming PPDU. The UEQM Pattern Index (2 bits) subfield may indicate the UEQM pattern recommended for the following/upcoming PPDU when the UEQM/DRU Indication subfield indicates UEQM. The UEQM Pattern Index subfield may be reserved when the UEQM/DRU Indication subfield indicates DRU.

The NSS (3 bits) subfield may indicate the number of spatial streams for the following/upcoming PPDU. In an example, the NSS subfield may signal the number of spatial streams only. In another example, the NSS subfield and UEQM Pattern Index subfield may be merged to one subfield (e.g., referred to as NSS/UEQM Pattern subfield). The subfield may have different meaning depending on the setting of the UEQM/DRU Indication subfield. For example, when the UEQM/DRU Indication subfield indicates UEQM, the NSS/UEQM Pattern subfield may refer to a look-up table in which one value of the subfield may indicate a combination of the number of spatial streams and the UEQM pattern index. When the UEQM/DRU Indication subfield indicates DRU, the subfield may indicate the number of spatial streams.

The BF (1 bit) subfield may indicate whether beamforming may be used in the upcoming PPDU with the parameters recommended. The PS160 (1 bit) subfield may indicate the primary 160 MHz channel or second 160 MHZ channel for the RU or MRU allocation if the size of RU or MRU is smaller than or equal to 2×996 tones. Otherwise, the PS160 subfield may indicate the RU or MRU index along with the RU Allocation subfield. The RU Allocation (8 bits) subfield may indicate which regular RU or MRU, or DRU, for which the UEQM/DRU Feedback Control is recommended. The RU Allocation subfield is interpreted with the BW subfield to specify the regular RU when the UEQM/DRU Indication subfield indicates UEQM; otherwise, a DRU is specified by information carried in PS160, RU allocation, and BW. The BW (3 bits) subfield may indicate the bandwidth for which the UEQM/DRU Feedback Control is recommended. The BW subfield may be interpreted with the RU Allocation subfield to specify the RU. When the UEQM/DRU Indication subfield indicates DRU, this may refer to the distribution BW of a DRU. The Target PPDU Type (2 bits) subfield may indicate the PPDU type (i.e., MU/SU PPDU or TB PPDU) for which all the above parameters carried in the UEQM/DRU Feedback Control subfield are recommended.

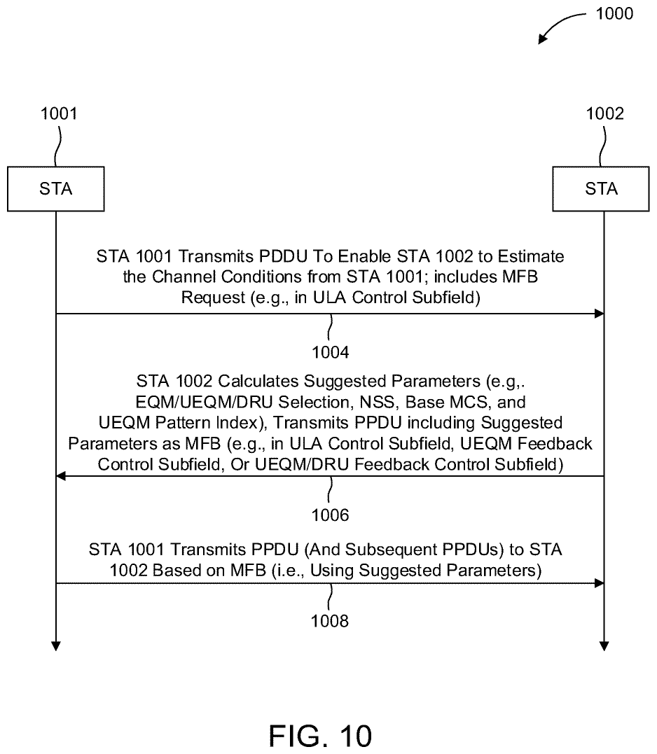

Example procedures for UHR link adaptation using a Control subfield, such as the A-Control subfield, are described herein. FIG. 10 is a signaling diagram illustrating an example link adaptation procedure 1000 using a solicitation (request) and response approach. In an example, STA 1001 may be an AP and STA 1002 may be another AP, or STA 1001 may be an AP and STA 1002 may be its associated non-AP STA, or STA 1001 may be a non-AP STA and STA 1002 may be its associated AP. STA 1001 may transmit, to STA 1002, a first PPDU 1004, which may include information requesting (soliciting) MCS feedback (MFB) from STA 1002. For example, the first PPDU 1004 may include a MAC frame with the HT Control field in its header, and the HT Control field include the ULA Control subfield (e.g., either Variant) to request/solicit MFB from STA 1002. For example, STA 1001 may set an Unsolicited MFB subfield to ‘0’ and MRQ/UL UHR TB PPDU MFB subfield to ‘1’ to indicate a request/solicitation for MFB from STA 1002. In an example, when using the ULA Control subfield Variant 1, if the UEQM/EQM subfield is set to ‘1’, the request is to solicit ULA feedback for UEQM; if UEQM/EQM subfield is set to ‘0’, the request is to solicit ULA feedback for EQM. When using the ULA Control subfield Variant 2, the request may be for either UEQM or EQM.

In response to PPDU 1004, STA 1002 may calculate the suggested MFB parameters based on the channel estimate information obtained through PPDU 1004. The suggested MFB parameters may include, but are not limited to include, any of the following: EQM/UEQM, NSS, (base) MCS, UEQM Pattern (if decided to use UEQM), and/or DRU parameters. STA 1002 may respond by sending, to STA 1001, PPDU 1006 including MFB information. For example, the MFB information may be included in any of the following: A-Control subfield of the HE variant HT Control field using the ULA Control subfield (either Variant); UEQM Feedback Control subfield; or UEQM/DRU Feedback Control subfield. In an example, if the ULA Control subfield (either Variant) is used, the Unsolicited MFB field may be set to ‘0’ and the MRQ/UL UHR TB PPDU MFB field may be set to ‘0’ for solicited MFB response. The UEQM/EQM indicator, if applicable, may be set to ‘1’ to indicate the response is suggesting UEQM, or ‘0’ to indicate the response is suggesting EQM. In response to receiving PPDU 1006, STA 1001 may use the suggested modulation schemes, as indicated by the received MFB, to transmit PPDU 1008 to STA 1002.

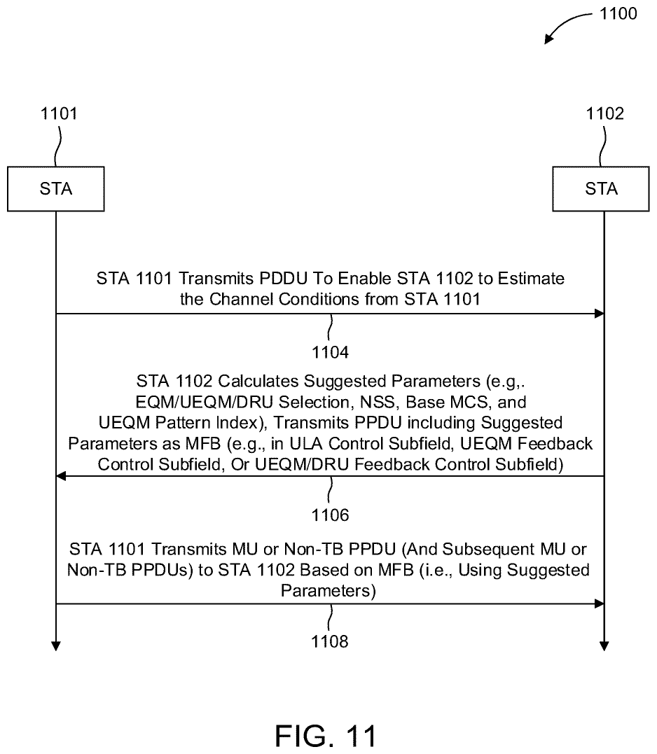

FIG. 11 is a signaling diagram illustrating an example link adaptation procedure 1100 using unsolicited MFB response for transmitting UHR MU PPDUs or non-TB PPDUs. In an example, STA 1101 may be an AP and STA 1102 may be a non-AP STA, or STA 1101 may be a non-AP STA and STA 1102 may be an AP. STA 1101 may send PPDU 1104 to STA 1102 to enable STA 1102 to estimate the channel conditions from STA 1101 to STA 1102. STA 1102 may estimate the channel conditions, from STA 1101 to STA 1102, based on PPDU 1104. STA 1102 may calculate one or more suggested MFB parameters based on the channel estimate information determined based on PPDU 1104. The suggested MFB parameters may include, but are not limited to include, any of the following: EQM/UEQM, NSS, (base) MCS, UEQM Pattern (if decided to use UEQM), and/or DRU parameters. STA 1102 may respond by sending, to STA 1101, PPDU 1106 including (unsolicited) MFB information. The MFB information may include, for example, one or more of the suggested MFB parameters. In an example, PPDU 1106 may include a MAC frame with a MAC header and a MAC body, and an HT Control field in the MAC header. Unsolicited MFB information, addressed to STA 1101, may be included in a subfield of the MAC header. For example, unsolicited MFB information may be included in a subfield of the HT Control field of the MAC header. Examples of subfields that may include the unsolicited MFB information include, but are not limited to: HLAVELA Control subfield, ULA Control subfield (either Variant), UEQM Feedback Control subfield, and/or UEQM/DRU Feedback Control subfield. In an example, if the unsolicited MFB information is included in the HLA/ELA Control subfield or the ULA Control subfield (either Variant), the unsolicited MFB information may be set to ‘1’ and the MRQ/UL UHR TB PPDU MFB may be set to ‘0’ for unsolicited MFB response that contains transmission scheme recommendations for STA 1101 to send future UHR MU PPDUs and/or UHR non-TB PPDUs. The PPDU 1106 may further include in the MAC header an EQM/UEQM subfield, which may indicate that STA 1102 prefers EQM or UEQM transmission from STA 1101 to STA 1102. Moreover, the EQM/UEQM subfield indicates to STA 1101 if other subfields correspond to EQM or UEQM. After receiving PPDU 1106, STA 1101 may transmit PPDU 1108 to STA 1102 based on the suggested modulation parameters. PPDU 1108 may be a UHR MU PPDU or non-TB PPDU.

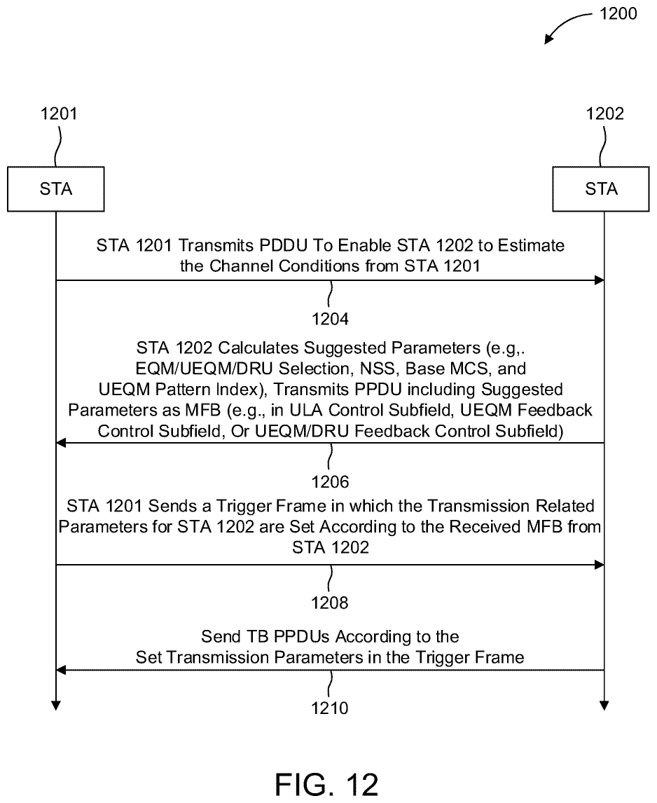

FIG. 12 is a signaling diagram illustrating an example link adaptation procedure 1200 using unsolicited response for UHR TB PPDUs. In an example, STA 1201 may be an AP and STA 1202 may be another AP or a non-AP STA associated with STA 1201. STA 1201 may send PPDU 1204 to STA 1202 to enable STA 1202 to estimate the channel conditions from STA 1201 to STA 1202. STA 1202 may estimate the channel conditions, from STA 1201 to STA 1202, based on PPDU 2104. STA 1202 may calculate one or more suggested MFB parameters based on the channel estimate information determined based on PPDU 1204, which may be used for transmission of future TB PPDUs sent from STA 1202 when triggered by STA 1201. The suggested MFB parameters may include, but are not limited to include, any of the following: EQM/UEQM, NSS, (base) MCS, UEQM Pattern (if decided to use UEQM), and/or DRU parameters. STA 1202 may respond by sending, to STA 1201, PPDU 1206 including MFB information. For example, PPDU 1206 may include a MAC frame with a MAC header and a MAC body, and an HT Control field in the MAC header. Unsolicited MFB information, addressed to STA 1201, may be included in a subfield of the MAC header. For example, unsolicited MFB information may be included in a subfield of the HT Control field of the MAC header. Examples of subfields that may include the unsolicited MFB information include, but are not limited to: HLA/ELA Control subfield, ULA Control subfield (either Variant), UEQM Feedback Control subfield, and/or UEQM/DRU Feedback Control subfield. The PPDU 1106 may further include in the MAC header an EQM/UEQM subfield, which may indicate that STA 1102 prefers EQM or UEQM transmission from STA 1202 to STA 1201. Moreover, the EQM/UEQM subfield indicates to STA 1101 if other subfields correspond to EQM or UEQM. In an example, if the unsolicited MFP information is included in the HLA/ELA Control subfield or the ULA Control subfield (either Variant), the Unsolicited MFB information may be set to ‘1’ and the MRQ/UL UHR TB PPDU MFB is set to ‘1’ for unsolicited MFB response for STA 1202 to send future UHR TB PPDUs. In an example, if the unsolicited MFB information is included in the UEQM Feedback Control subfield or the UEQM/DRU Feedback Control subfield, the Target PPDU Type field may be set to indicate TB PPDU. After receiving PPDU 1206, STA 1201 may transmit PPDU 1208 including a Trigger frame to STA 1202. The MCS field and/or other modulation-related fields in the Trigger Frame 1208 may include suggested modulation parameters based on the unsolicited MFB response for TB PPDUs provided by STA 1202 in PPDU 1206. After receiving PPDU 1208, STA 1202 may transmit PPDU 1210 to STA 1201 based on the suggested modulation parameters. PPDU 1210 may be a UHR TB PPDU triggered by the Trigger frame in PPDU 1208.

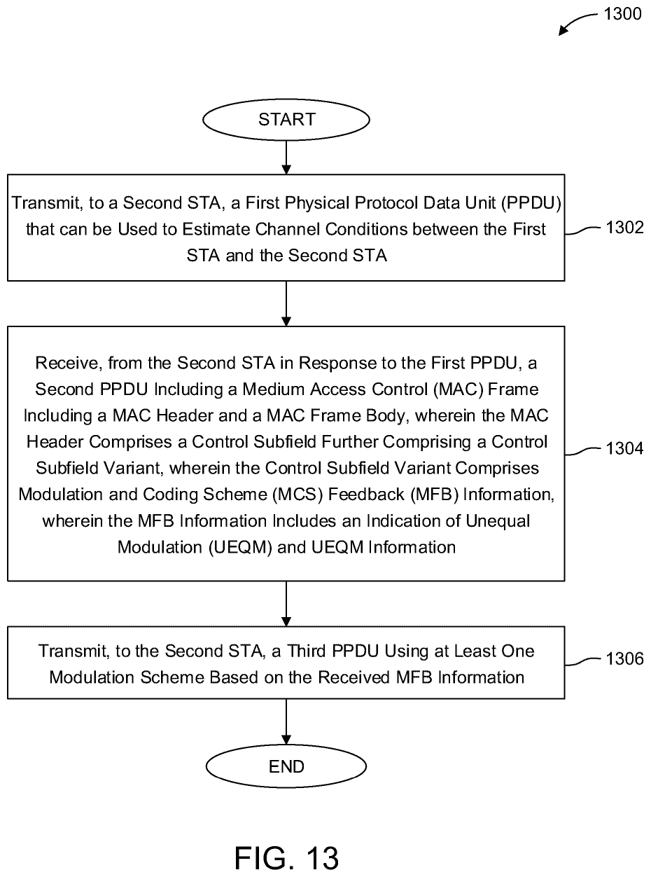

FIG. 13 is a flow diagram illustrating an example procedure 1300 for MAC layer signaling to enable equal and unequal modulation across spatial streams and accommodate new modulation and coding schemes for transmission. Procedure 1300 may be performed by a first STA (e.g., an AP or a non-AP STA). At 1302, the first STA may transmit, to a second STA, a first physical protocol data unit (PPDU) that can be used to estimate channel conditions between the first STA and the second STA. At 1304, the first STA may receive, from the second STA in response to the first PPDU, a second PPDU including a medium access control (MAC) frame including a MAC header and a MAC frame body, wherein the MAC header comprises a control subfield further comprising a control subfield variant, wherein the control subfield variant comprises modulation and coding scheme (MCS) feedback (MFB) information, wherein the MFB information includes an indication of unequal modulation (UEQM) and UEQM information. At 1306, the first STA may transmit, to the second STA, a third PPDU using at least one modulation scheme based on the received MFB information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A first station (STA) comprising:
a transceiver; and
a processor,
wherein the transceiver and processor are configured to:
transmit, to a second STA, a first physical protocol data unit (PPDU) that can be used to estimate channel conditions between the first STA and the second STA;
receive, from the second STA in response to the first PPDU, a second PPDU including a medium access control (MAC) frame including a MAC header and a MAC frame body, wherein the MAC header comprises a control subfield further comprising a control subfield variant, wherein the control subfield variant comprises modulation and coding scheme (MCS) feedback (MFB) information, wherein the MFB information includes an indication of unequal modulation (UEQM) and UEQM information; and
transmit, to the second STA, a third PPDU using at least one modulation scheme based on the received MFB information.

2. The first STA of claim 1, wherein the transceiver and processor are further configured to:
transmit, to the second STA, a trigger frame including information on transmission related parameters, wherein the transmission related parameters are set based on the received MFB information; and
receive, from the second STA in response to the trigger frame and based on the transmission related parameters, a trigger-based (TB) PPDU.

3. The first STA of claim 1, wherein the first PPDU includes information requesting MFB or the MFB information is unsolicited.

4. The first STA of claim 1, wherein the control subfield variant is an A-Control subfield variant of a high efficiency (HE) variant high throughput (HT) Control field.

5. The first STA of claim 4, wherein the control subfield variant is one of: high efficiency link adaptation (HLA)/Extremely High Throughput (EHT) link adaptation (ELA) Control subfield, Ultra High Reliability (UHR) Link Adaptation (ULA) Control subfield, UEQM Feedback Control subfield, or UEQM/distributed resource unit (DRU) Feedback Control subfield.

6. The first STA of claim 1, wherein the MFB information further includes at least one of: equal modulation (EQM)/UEQM information, number of spatial streams (NSS) information, modulation and coding scheme (MCS) information, UEQM Pattern information, and distributed resource unit (DRU) information.

7. The first STA of claim 1 configured as a non-access point (non-AP) STA or an access point (AP), wherein the third PPDU is an ultra high reliability (UHR) multi-user (MU) PPDU or a non-trigger based (TB) PPDU.

8. A method performed by a first station (STA), the method comprising:
transmitting, to a second STA, a first physical protocol data unit (PPDU) that can be used to estimate channel conditions between the first STA and the second STA;
receiving, from the second STA in response to the first PPDU, a second PPDU including a medium access control (MAC) frame including a MAC header and a MAC frame body, wherein the MAC header comprises a control subfield further comprising a control subfield variant, wherein the control subfield variant comprises modulation and coding scheme (MCS) feedback (MFB) information, wherein the MFB information includes an indication of unequal modulation (UEQM) and UEQM information; and
transmitting, to the second STA, a third PPDU using at least one modulation scheme based on the received MFB information.

9. The method of claim 8, further comprising:
transmitting, to the second STA, a trigger frame including information on transmission related parameters, wherein the transmission related parameters are set based on the received MFB information; and
receiving, from the second STA in response to the trigger frame and based on the transmission related parameters, a trigger-based (TB) PPDU.

10. The method of claim 8, wherein the first PPDU includes information requesting MFB or the MFB information is unsolicited.

11. The method of claim 8, wherein the control subfield variant is an A-Control subfield variant of a high efficiency (HE) variant high throughput (HT) Control field.

12. The method of claim 11, wherein the control subfield variant is one of: high efficiency link adaptation (HLA)/Extremely High Throughput (EHT) link adaptation (ELA) Control subfield, Ultra High Reliability (UHR) Link Adaptation (ULA) Control subfield, UEQM Feedback Control subfield, or UEQM/distributed resource unit (DRU) Feedback Control subfield.

13. The method of claim 8, wherein the MFB information further includes at least one of: equal modulation (EQM)/UEQM information, number of spatial streams (NSS) information, modulation and coding scheme (MCS) information, UEQM Pattern information, and distributed resource unit (DRU) information.

14. The method of claim 8, wherein the first STA is configured as a non-access point (non-AP) STA or an access point (AP), and wherein the third PPDU is an ultra high reliability (UHR) multi-user (MU) PPDU or a non-trigger based (TB) PPDU.

15. A first station (STA) comprising:
a transceiver; and
a processor,
wherein the transceiver and processor are configured to:
receive, from a second STA, a first physical protocol data unit (PPDU);
estimate, based on the received first PPDU, channel conditions between the first STA and the second STA;
calculate MFB parameters based on estimated channel conditions;
transmit, to the second STA, a second PPDU including a medium access control (MAC) frame including a MAC header and a MAC frame body, wherein the MAC header comprises a control subfield further comprising a control subfield variant, wherein the control subfield variant comprises modulation and coding scheme (MCS) feedback (MFB) information, wherein the MFB information includes an indication of unequal modulation (UEQM) and UEQM information; and
receive, from the second STA, a third PPDU using at least one modulation scheme based on the received MFB information.

16. The first STA of claim 15, wherein the transceiver and processor are further configured to:
receive, from the second STA, a trigger frame including information on transmission related parameters, wherein the transmission related parameters are set based on the received MFB information; and
transmit, to the second STA in response to the trigger frame and based on the received transmission related parameters, a trigger-based (TB) PPDU.

17. The first STA of claim 15, wherein the first PPDU includes information requesting MFB or the MFB information is unsolicited.

18. The first STA of claim 15, wherein the control subfield variant is an A-Control subfield variant of a high efficiency (HE) variant high throughput (HT) Control field.

19. The first STA of claim 18, wherein the control subfield variant is one of: high efficiency link adaptation (HLA)/Extremely High Throughput (EHT) link adaptation (ELA) Control subfield, Ultra High Reliability (UHR) Link Adaptation (ULA) Control subfield, UEQM Feedback Control subfield, or UEQM/distributed resource unit (DRU) Feedback Control subfield.

20. The first STA of claim 15, wherein the MFB information includes at least one of: equal modulation (EQM)/UEQM information, number of spatial streams (NSS) information, modulation and coding scheme (MCS) information, UEQM Pattern information, and distributed resource unit (DRU) information.
